(19) United States
(12) Patent Application Publication
(10) Pub. No.: US 2006/0282234 A1
(43) Pub. Date: Dec. 14, 2006

(54) Method of designing a structural element

(75) Inventor: Alan Victor Pottage, Scarborough (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Fabsec Limited, Leeds (GB)

(21) Appl. No.: 11/442,198

(22) Filed: May 26, 2006

Related U.S. Application Data
(63) Continuation of application No. 10/181,112, filed on Dec. 19, 2002, now abandoned.

(30) Foreign Application Priority Data
Jan. 13, 2000 (GB) GB 0000672.6

(51) Int. Cl. G06F 17/50

(52) U.S. Cl. 703/1

(57) ABSTRACT

A method of designing a structural element comprising providing a value for a plurality of parameters of the structural element and a plurality of loads to be supported thereby, performing an analysis step of calculating a plurality of properties of said structural element at a plurality of discrete locations on said structural element, and displaying the results of said analysis step.

### CROSS-REFERENCE TO RELATED APPLICATIONS

This is a continuation application claiming the benefit of priority to U.S. patent application Ser. No. 10/181,112, filed Dec. 19, 2002, the entire disclosure of which is hereby expressly incorporated herein by reference and is the national phase of PCT/GB00/01324, having an international filing date of Apr. 7, 2000 and claiming priority to GB 0000672.6, filed Jan. 13, 2000.

### FIELD OF THE INVENTION

This invention relates to a method for designing structural elements, particularly but not exclusively structural beams.

### BACKGROUND OF THE INVENTION

When designing or selecting a structural element to perform a desired function, a designer must take into account a wide range of factors, for example the load the element is to bear, the dimensions of the element, whether openings are provided in the element and the cost of the element. To optimise all the relevant factors can be a lengthy process. In such a structural element, it may be desirable to provide one or more apertures to permit the passage of building services and to reduce the weight of the beam. In a structural element comprising generally vertical web, such apertures may be provided in the web.

### SUMMARY OF THE INVENTION

An aim of the invention is to provide a new or improved method of designing a structural element.

According to a first aspect of the invention we provide a method of designing a structural element comprising providing a value for a plurality of parameters of the structural element and a plurality of loads to be supported thereby, performing an analysis step of calculating a plurality of properties of said structural element at a plurality of discrete locations on said structural element, and displaying the results of said analysis step.

Where the structural element is to comprise an aperture, at least one of said parameters may be a parameter of said aperture and at least one of said properties may be a property of said structural element at said aperture.

The method may further comprise a comparison step of comparing at least one of said properties with a predetermined criterion.

Said plurality of locations may comprise a plurality of sections of said structural element located to be longitudinally disposed along said structural element.

The method may comprise the step of displaying the section wherein a desired one of said properties has a value having the greatest deviation from said predetermined criterion.

The method may comprise the step of changing the value of one or more of said plurality of parameters such that said deviation of the value of said property from said predetermined criterion is reduced.

A plurality of properties may be compared with a corresponding one of a plurality of predetermined criteria.

Said comparison of each property and a corresponding predetermined criterion may be expressed as a unity factor such that where said unity factor is greater than 1, said property is a failure mode.

Said structural element may comprise a web and at least one flange and said parameters may comprise the web and flange thickness and depth.

The method may comprise the step of selecting at least one of said parameters of said structural element and/or said load applied to said structural element from a library of predetermined values for said parameters and/or said load.

The method may comprise the step of calculating a unity value for a plurality of properties for each discrete locations, and for each property displaying the location with the least acceptable unity value.

The method may comprise an output stage of providing an output comprise the parameters of the structural element.

The method may further comprise the step of manufacturing a structural element in accordance with said output.

The output may be in a potable or transmittable form.

According to a second aspect of the invention, we provide a structural element where said structural element is designed by a method according to the first aspect of the invention.

The structural element may comprise plate metal.

The structural element may be provided with apertures.

The structural element may comprise a composite beam.

According to a third aspect of the invention, we provide a computer program for performing a method according to the first aspect of the invention.

According to a fourth aspect of the invention, we provide a computer where programmed with a program according to the third aspect of the invention.

According to a fifth aspect of the invention, we provide manufacturing means for manufacturing a structural element, comprising a computer according to the fourth aspect of the invention and a manufacturing apparatus wherein an output is supplied from said computer to said manufacturing apparatus to control said manufacturing apparatus.

According to a sixth aspect of the invention, we provide a method of manufacturing a structural element comprising supplying an output from a computer program according the third aspect of the invention to a manufacturing apparatus to control said manufacturing apparatus.

The step of transmitting an output from a computer program may comprise the step of preparing a data file.

### BRIEF DESCRIPTION OF THE DRAWINGS

The invention will now be described by way of example only with reference to the accompanying drawings, wherein

FIG. 1a is a side view of a first example of a structural element,

FIG. 1b is a side view of a second example of a structural element,

FIG. 1c is a side view of a third example of a structural element,

FIG. 1d is a side view of a fourth example of a structural element,

FIG. 2 is a side view of a fifth example of a structural element,

FIG. 3a is a flow chart of a first stage of a method according to the present invention,

FIG. 3b is a flow chart of a second stage of a method according to the present invention, and

FIG. 3c is a flow chart of a third stage of a method according to the present invention.

### DETAILED DESCRIPTION OF THE INVENTION

In the present example, the method according to the invention is intended for use with structural elements comprising beams. Such beams are disposed in a generally horizontal orientation to provide part of a grid to provide support for a floor or roof. Such a beam may comprise a composite beam, that is the beam supports at least part of a concrete slab to provide a floor, and the beam is keyed to said slab by means of projections on an upper surface of said beam received in said concrete slab, referred to as a shear connection. Such a configuration permits a beam to be provided having a longer span or to support a greater load than might otherwise be possible in view of the beam dimensions. A grid conventionally comprises a plurality of such beams, conventionally referred to as primary beams and secondary beams. The concrete slab load passes firstly into the secondary beams, which extend between the primary beans, and thence into the primary beams, which extend between appropriate supports, for example columns.

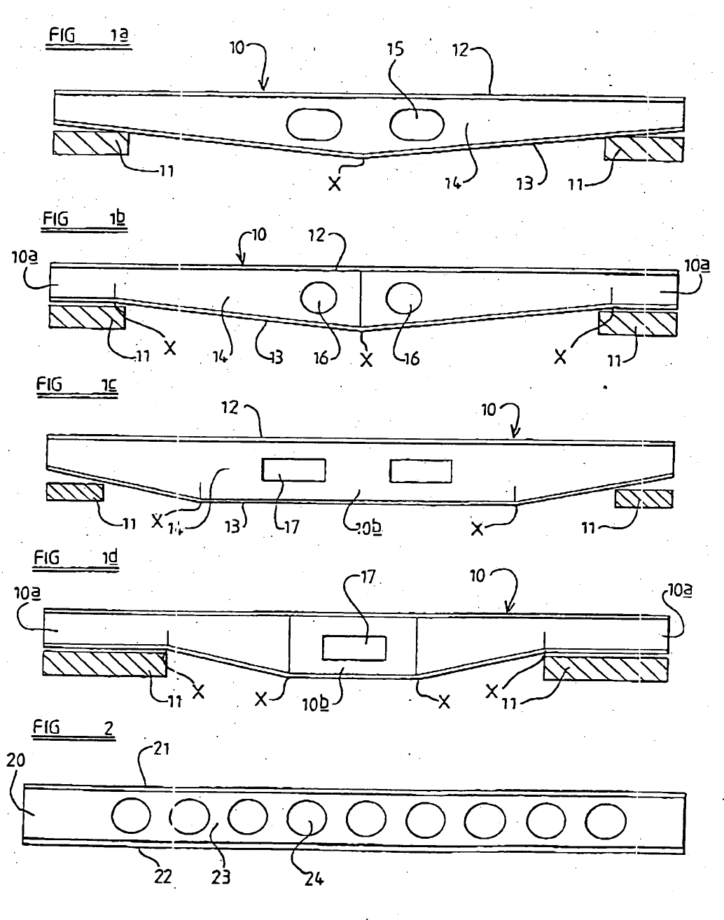

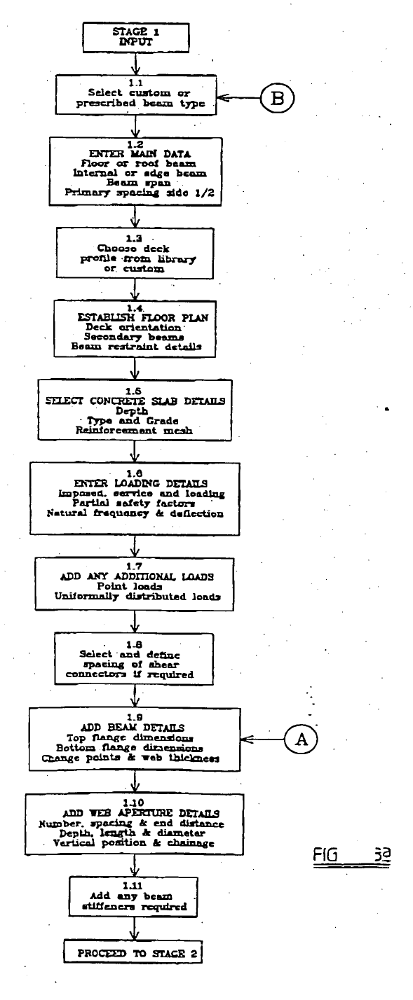

The beam may be prismatic or non-prismatic over part or all of its length, and may have one or more apertures of desired shape as shown in the Figures. Referring to FIG. 1a, a structural element comprising a beam 10 is shown with service ducting 11. The beam 10 has an upper flange 12 and a lower flange 13 connected by a web 14. A pair of elongate apertures 15 are provided in the web 14 located generally symmetrically about the mid point of the beam 10. The upper flange 12 and lower flange 13 are not parallel, but taper with increasing beam depth in a direction towards the mid point of the beam 10. Such a configuration is referred to as a ‘single taper’. A point at which the angle of the flange 13 changes is referred to as a ‘change point’ and is indicated at X in the Figures. A change of web thickness is also referred to as a ‘change point’.

FIG. 1b shows a beam 10 similar to that of FIG. 1a, but provided with end parts 10_ wherein the upper flange 12 and lower flange 13 are generally parallel, a configuration referred to as ‘a cranked taper’. The beam 10 further comprises round apertures 16 provided in the web 14.

FIG. 1c shows a beam 10 having a central portion 10b wherein the upper flange 12 and lower flange 13 are generally parallel, a configuration referred to as ‘double taper’, and wherein a pair of rectangular apertures 17 are provided located generally symmetrically about the mid point of the beam 10.

FIG. 1d shows a beam 10 similar to that of FIG. 1c but provided with end parts 10_ in like manner to the beam of FIG. 1a, and with a single aperture 17 referred to as ‘gullwing’.

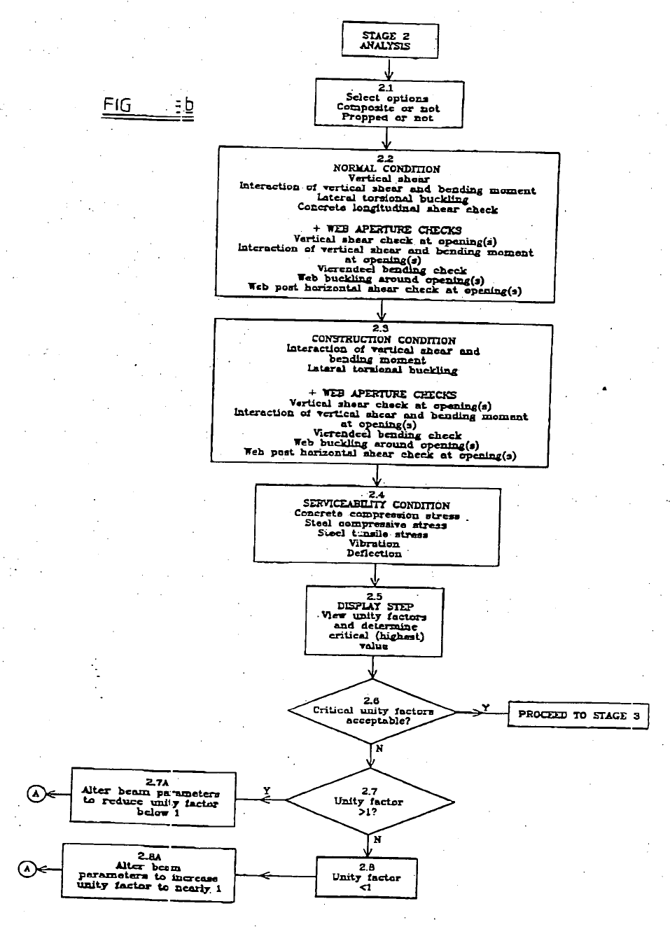

FIG. 2 shows a beam 20 having an upper flange 21 and lower flange 22, interconnected by a web 23 provided with a plurality of circular apertures 24.

The configurations of the beams 10, 20 shown in FIGS. 1a-1d, 2 are not exclusive, but simply illustrate the freedom of choice of beam dimension and shape available to the designer. The beam may be asymmetric, curved, tapered or multi-faceted as desired. The apertures 15, 16, 17 are shown located generally symmetrically on the beam, but may be located anywhere as desired on the beam, whether symmetrically or otherwise.

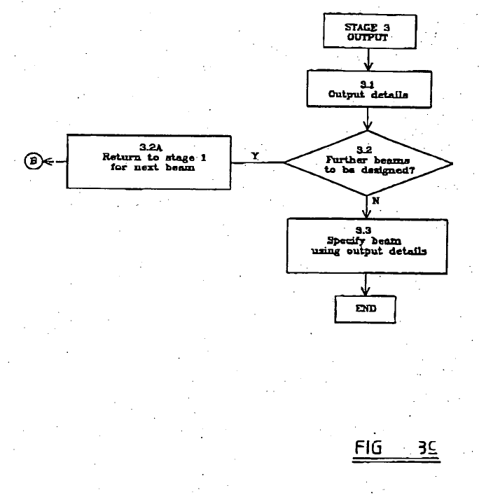

Referring now to FIGS. 3a to 3c, the various steps of the method according to this invention are shown as a flow chart. The method may be broken down into three stages, a first, input stage as shown in FIG. 3a, an analysis stage shown in FIG. 3b and an output stage shown in FIG. 3c. In the present example, the method is envisaged as being performed by a computer program and designer.

In the input stage of the method, the relevant parameters of the beam and the load and application of the beam are entered. In step 1.1 a beam type may be selected from a library of redefined beam types, or alternatively a customised beam type may be provided by the designer.

In steps 1.2 to 1.5, data on the beam size and load is provided. In step 1.2, it is specified the beam is a floor or roof beam, whether the beam is to be an internal beam or an edge beam, the distance to be spanned by the beam and the distance to adjacent beams on each side. The profile of the deck to be supported by the beam is then provided. Again, the profile may be selected from a library of predefined profiles or the parameters for a preferred profile may be provided. The floor plan is then entered including the orientation of the deck, the location and number of secondary beams and beam restraint details.

Details of the concrete slab to be supported by the beam are then entered, including the depth of the slab, the type and grade of the components of the slab and of the reinforcement mesh provided in the slab.

At steps 1.6 and 1.7, the details of the load to be borne by the building are entered, including imposed, service and wind loading, any partial safety factors and the limits of the natural frequency and deflection of the structure.

In step 1.7, any load additional to those imposed by the floor plan and loading details are entered, both point loads and uniformly distributed loads. This input can be confirmed by displaying a configuration of a typical bay.

If shear connectors are to be used, the number and spacing are entered in step 1.8.

In steps 1.9, 1.10 and 1.11, parameters of the beam are provided, in particular, the top and bottom flange dimensions, the web depth and thickness and details of any change point in the beam, together with the number, spacing and size of any apertures in the web and the provision of any beam stiffeners.

The input stage thus allows the designer to provide the details of the beam shape, web openings, web stiffeners, beam geometry between change points and other parameters as desired. Such parameters may be selected from a library of predetermined shapes or parameters, or where the method is implemented on a computer program, may be determined by said program.

It may be envisaged, that where the method is implemented on a computer program or otherwise, suitable graphical displays may be provided to confirm the parameters entered.

Once the desired values for these parameters have been provided, the analysis stage is then performed.

Referring now to FIG. 3b, the analysis stage asks for further information as to whether the beam is composite or not and whether it is to be propped or not, and the steel grade. Checks for three calculation conditions are then performed in steps 2.2, 2.3 and 2.4 in FIG. 3.

Step 2.2 is the so-called “normal condition” where checks are made on the properties of the beam in situ in a finished building i.e. when the structure of which the beam is to form a part is complete. The ultimate limit calculations are performed for a plurality of properties at each of a plurality of discrete locations, in the present example discrete sections disposed longitudinally spaced along the length of the beam. The sections may be equidistant from one another or may be spaced otherwise as necessary. In step 2.2, the applied load is first calculated and then four main properties calculated;

1) the vertical shear force on the beam and the bending moment,

2) the interaction of the bending moment and vertical shear,

3) the lateral torsional buckling of the beam, and

4) the concrete longitudinal shear resistance.

Further properties which may be calculated include any necessary transverse reinforcement, and the weld throat thickness.

The calculated values are compared to a predetermined criterion and a unity value calculated for the discrete section having the least acceptable calculated value of that property.

A unity value for a given property is a unitless value indicating whether the calculated value for a given property meets the predetermined criterion. If the unity value is greater than 1, this indicates a failure mode i.e. the calculated value fails to meet the predetermined criterion. A value of 1 shows that the value of the property exactly meets the predetermined criteria, and of less than 1 shows that the value of the property is more than sufficient to meet the criteria. In practice, optimisation of the design requires that each unity value be less than but approaching 1. The unity value may be calculated by calculating the ratio if the calculated value with actual forces in the element.

Where the beam comprises adjacent sections having differing tapers, properties relating to the stability of the web and flange at or near a junction between two such sections is calculated. The properties comprise:

1) the maximum change angle, ie the maximum difference in the angle of taper between the two sections,

2) the web buckling resistance, and

3) the web bearing resistance.

For the web buckling resistance and the web bearing resistance, the calculated value is compared to a predetermined criterion and a unity value calculated for the discrete section having the least acceptable calculated value of that property.

Where the web is provided with one or more apertures, further calculations are performed at a plurality of points, in the present example around the aperture.

Using the results of these calculations, a unity value for each of the following properties, each representing a failure mode, is calculated;

1) modified calculation of vertical shear,

2) interaction of vertical shear and bending moment,

3) Vierendeel capacity,

4) web buckling capacity, and

5) web post horizontal shear.

In the next step 2.3 of the analysis stage, the so-called ‘construction condition’ the properties of the beam are checked for the condition when it is in situ but when no load, e. g. from a floor slab, is applied. The following properties are checked;

1) interaction of the bending moment capacity and vertical shear capacity in the absence of the concrete slab, and

2) the lateral torsional buckling of the beam.

Where one or more apertures are provided in the web, the following properties are calculated for a section through the centerline of the or each aperture as in step 2.2 above;

1) modified calculation of vertical shear,

2) interaction of vertical shear and bending moment,

3) Vierendeel capacity,

4) web buckling capacity, and

5) web post horizontal shear.

Again, the calculated value for each property is compared to a predetermined criterion and a unity value calculated for the discrete section having the least acceptable calculated value of that property.

In step 2.4 of the analysis stage, the serviceability condition”, the following properties are calculated.

1) concrete compressive stress,

2) steel tensile stress,

3) steel compressive stress,

4) natural frequency of vibration of the beam

For each of these properties a unity value is calculated as in steps 2.2 and 2.3 above.

In the serviceability condition, a check may also be made on the deflection of the beam. The deflection checks may include, in the construction condition, the self weight deflection of the beam when propped or propped. In the normal condition, the deflection due to imposed loads and superimposed dead loads may be calculated on the basis of the composite beam properties, and a total deflection check be performed. The deflection checks in the present example do not generate a unity value, but are instead compared to predetermined criteria provided by the designer, for example the maximum acceptable total deflection of the beam. In the present example, deflection checks are optional and any or all may be selected or omitted by the designer.

At the display step 2.5, each property is displayed, together with the ‘critical value’ the corresponding unity value for a discrete section having the least acceptable calculated value of that property (usually the maximum value), or other indication of the comparison with a corresponding criterion, or calculated value for the property, as appropriate.

If at step 2.6 the critical values are acceptable, the designer proceeds to stage 3 of the method. Where a unity value exceeds 1 as in step 2.7, the value for that property in the relevant section is ‘critical’ and hence likely to lead to failure of the beam. The information thus displayed draws the designer's attention to where the beam is deficient. The designer may then revise the values of the parameters (step 2.7A) and supply the amended parameters at the input step 1.10.

The designer then returns lo the input stage to modify the beam details accordingly.

However, when a unity factor is substantially below 1 (step 2.8), this indicates that the beam is over-designed for the intended load. To reduce beam weight, cost etc. it is desirable to increase the unity factor towards 1 whilst remaining below 1, thus optimising the design. The information displayed thus permits the designer to quickly identify those sections of the beam where the design can be optimised and revise the beam parameters accordingly (step 2.8A). The revised beam parameter values are entered at step 1.10.

The process of revising the beam parameters and viewing the calculated unity factors can be performed iteratively until, at step 2.6, the critical factors are acceptable, i.e. the unity factors are all below 1 but sufficiently close thereto for the design to be sufficiently optimised and the method proceeds to the output stage.

At the output stage, as shown in FIG. 3c the details are output at step 3. 1, for example by saving to a data file, or in any other format as desired.

When the beam parameters are output, the parameters may be supplied as a printed document, in for example a standard format, or may be supplied as a computer data file in an appropriate format, for example on a computer disc, or tape, or any other medium, or displayed on a screen, or in any form as desired.

It might be envisaged that such a data file could be, for example, transmitted by email to the client and/or to the beam fabricator. At step 3.2, the process is then repeated for all beams for which design is required. Finally, at step 3.3 when the parameters for all desired beams are all specified, it might be at this stage that a supplier may be contacted for details of the design, supply and fabrication costs of the beams, or the closest match from a library of predetermined beam types may be indicated and selected accordingly.

When an appropriate final design is arrived at, a cost may be calculated for a structural element according to the design, fabrication drawings prepared, or indeed a manufacturing apparatus be controlled to fabricate a structural element according to the design. Such a manufacturing apparatus may for example comprise cutting means to cut sheet metal to provide a web part and/or flange parts of desired shape, and may further cut apertures in the web part.

The manufacturing apparatus may further or alternatively comprise welding means to join the web part and flange parts to form a beam. Such an apparatus is disclosed in our co-pending application no. GB9926197.6. Of course, any appropriate manufacturing apparatus may be used as desired. Where the method is performed using a computer program, the computer may be provided as part of a manufacturing means comprising said manufacturing apparatus.

The provision of a plurality of standard beam parameters in a library as part of the program thus further accelerates the design process by providing that some or all of the parameters of the beam need not be supplied by the designer.

The analysis stage described herein and as discussed in more detail below provides a more rigorous vibration analysis than known methods. The calculation of the properties of the beam at predetermined sections provides for faster implementation of the analysis stage than previously known techniques, for example finite element analysis and elastic analysis programs.

Detailed Discussion of Analysis Stage.

Step 2.2 Normal Condition

The self weight loads are calculated in addition to the uniformly distributed loads and additional loads specified at the input stage, using the dry density of the concrete, and adding the weight of the beam and decking.

Section Shear Check:

When checking the section for shear force only, the shear capacity is calculated ignoring the contribution of the concrete slab. Therefore reference must be made to BS5950: Part 1 cl. 4.2.3 (shear yielding resistance) and cl. 4. 4. 5 (shear buckling resistance). A cross-section web is classified as thin when d/t exceeds 63ε (with ε=√{275/p_{y}}). In this case the software uses the procedure proposed in BS 5950: Part 1 (Anne H2) “Shear buckling resistance utilizing tension field action”.

The critical location is at the left hand support where in this case the web is not thin, the shear yielding capacity is calculated: Pᵥ=0.6 p_{y} Aᵥ.

Degree of Shear Connection:

The degree of shear connection is defined as the ratio between the number of shear connectors that are provided and the number connectors necessary for full interaction. This has been calculated according to BS5950: Part 3 cl. 5.4.4.1: Nₚ=Fₚ/Qₚ where Qₚ is the capacity of a shear connector in positive moment regions (BS 5950: Part 3 cl. 5.4.3-a) and Fp is the longitudinal compressive force in the concrete flange at the point of maximum positive moment. It is taken as the smaller of Ap_{y}, and 0.45 f_{cu} times the area of concrete within the effective cross-section.

Since BS5950: Part 3 does not cover the case of non-symmetrical beams the minimum degree of shear connection is calculated according to EC4 cl. 6.1.2. For equal flanged beams with span between 5 and 25 m, EC4 recommends: Nₐ/Nₚ≧0.25+0.03 L.

Interaction of Bending Moment and Vertical Shear:

Vertical Shear Capacity:

In case of interaction with bending moment, allowance has been made for the contribution of the concrete slab to the shear capacity of the section. This is calculated according to the rules for punching shear BS5950: Part 4.

Where the web is not thin, failure occurs by yielding and the shear capacity is calculated according to BS5950: Part 1 cl. 4.2.3.

The concrete shear capacity is calculated multiplying the concrete stress times the effective area of the concrete section. Its depth is equal to the net thickness of the slab while its width is equal to the steel top flange breadth plus 1.5 times the flange net depth on each side of the beam.

Bending Moment Capacity:

The longitudinal shear resistance R_{q} (defined in BS5950: Part 1 Appendix B2) is used to define the depth of concrete in compression d_{c}=(Dₛ−Dₚ)R_{q}/R_{c}. It replaces the net depth of the slab (Dₛ-Dₚ) in calculating the bending capacity of the composite section for partial shear interaction.

In singly supported beams, the effective width at mid-span is calculated according to BS5950: Part 3 cl. 4. 6. Since the beam is simply supported, the distance between the points of zero moment is equal to the span of the beam, and therefore B_{eff}=2 L/8. The effective width has been assumed as linearly varying along the depth of the beam, and its value at the supports is zero.

BS5950 Appendix B provides a range of formulas to calculate the plastic moment capacity for sections with equal flanges. This software has used more general equations, valid also in the case of non-symmetrical sections.

Where the case of low shear interaction applies no reduction of the bending moment capacity is necessary.

In “full output” at the output step the relevant data necessary to calculate the moment and shear capacity in each section are provided.

Longitudinal Shear Resistance Check:

The longitudinal shear connector check is carried out in accordance with BS5950: Part 3 cl. 5.6. The design longitudinal shear force per unit length is calculated according to cl. 5.6.2. It is given by the ratio of the longitudinal force that can be transmitted by each group of studs to the spacing between each group. In order to take account of the actual maximum longitudinal shear stress that can be resisted by the concrete flange, the longitudinal shear force is reduced by the ration of the applied factored moment to the moment capacity of the section for the actual degree of shear connection. Effectively, the shear stress is considered to vary in proportion to the moment ratio. For composite slabs, the longitudinal shear force is critical along the vertical planes parallel to the direction of the beam located in the position of minimum slab depth, therefore the unit force on each plane is: υ=(M_{sd}/M_{c})NQ/2ₛ

where N is the number of shear connectors in a group.

Q is the capacity of the shear connector according to cl. 5.4.3, modified for the case of studs embedded in a composite slab according to cl. 5.4.7.

s is the minimum spacing of the studs.

In order to allow for the possibility of lap joints close to the beam position, in calculating the resistance to splitting of the line of shear connectors (i. e. transverse reinforcement check) the deck contribution (according to cl. 5.6.4) has been ignored.

In calculating the concrete shear area per unit length the net minimum depth of the slab is used. The longitudinal shear capacity of the concrete flange alone has been calculated according to cl. 5.6.3: υᵣ≦0.8ηA_{cv} √f_{cu}

Transverse Reinforcement Check:

In this case, no reduction factor has been used for the design longitudinal shear force. The transverse resistance of the concrete and the mesh are calculated according to cl. 5.6.3 υᵣ=0.7Aₛᵥ f_{y}+0.03ηA_{cv}fₑₙ. Since this is smaller than the longitudinal shear force, additional reinforcement is necessary which is determined according to: Aᵥₛ′=(υ−υᵣ)/0 7f_{y}, The cross-section area of additional reinforcement is output as mm 2/m. This reinforcement is continuous over the beam.

Weld Design:

The weld throat thickness is calculated using the more conservative of the following three criteria:

i) throat thickness resisting the stud shear flow

ii) throat thickness resisting the moment shear flow

iii) throat thickness corresponding to 80% of the web yield capacity

The stud shear flow is the capacity of a shear connector divided by the minimum spacing. The program calculates the moment shear flow in each of the 51 sections in which all the checks are carried out and provides in output the critical location. The moment shear flow is given by tensile stress in the bottom flange times its area. The tensile stress on each side of the considered element is calculated as the yield stress times the unit factor for combined bending moment and shear force at the corresponding location. Therefore the following formula applies: υ=(ufᵢA_{bi}−ufᵢ₋₁A_{bi-1})p_{y}/s. In the “full output”, the unity factors at all the 51 sections are presented. At the support position, the stress on the LHS of the element is zero. The throat thickness corresponding to 80% of the web yield capacity is: a=0.8 0.6 p_{y}t_{w}/0.7p_{w}. The weld force per unit length v is the maximum value between the stud shear flow and the moment shear flow. The weld size is established by the equation: a=υ/0.7p_{w}.

Local Checks at Change Points:

Local checks are made on the stability of the web and the flange at the change of taper. At these positions, checks are made on:

Flange Ripping

Caused by transverse bending of the flange due to the change of direction of the flange force. The maximum change angle is also presented and it is calculated by the following formula: sin a′=4t₁(1−UF_{b}²)/(B.UF_{b}) where:

B is the width of the bottom flange

UFb is the unity factor for bending for the section where the change of taper occurs. If this value is exceeded, a full depth stiffener is required at the change point.

Web Buckling Resistance

Caused by vertical components of the flange forces at the point of change of taper. It is calculated using a modified strut approach according to BS5950: Part 1 cl. 4. 5. 2. Therefore the buckling capacity is calculated as: P_{w}=n₁t_{w}P_{c}

where: n₁ is the width of the equivalent strut, calculated assuming 45° dispersion

t_{wmin} is the minimum thickness of the web

P_{c} is the buckling stress corresponding to the buckling curve c in BS5950: Part 1 Table 4.14. It depends on the slenderness λ=h_{eff}/r_{y}

r_{y} is the radius of gyration (=t/√12)

h_{eff} is the effective length of the strut element. It is taken as 0.85 times the depth of the web which is the value suggested in BS5950: Part 1 table 4.12 for a strut partially restrained at both ends

This failure mode is not critical if the calculated unity factor does not exceed 1.0.

Web Bearing Resistance

Caused by the same force as for buckling. In this case a greater dispersion is assumed, due to the bending of the flange. The bearing capacity of the web is calculated as: P_{w}=n₂t_{w}p_{yw}, where:

n₂ is the bearing length taken as 7 times the thickness of the flange

t_{wmin} is the minimum thickness of the web

p_{yw} is the yield stress of the web

The failure mode is not critical if the calculated unity factor does not exceed 1.0.

Step 2.3 Construction Condition

Interaction of Bending Moment and Vertical Shear

Vertical Shear Capacity:

In the construction condition, reference must be made to BS5950: Part 1 cl. 4.2.3 (shear yielding resistance) and cl. 4.4.5 (shear buckling resistance). A cross-section web is classified as thin when d/t exceeds 63ε (with ε=√{275/p_{y}}).

Where the web is not thin, the shear yielding capacity is calculated as: Pᵥ=0.6p_{y}Aᵥ. Since the applied shear does not exceed 0.6 P,, interaction between bending moment and shear force is not taken into account. Shear resistance is not critical in the construction condition.

Bending Moment Capacity:

The bending moment capacity is calculated according to BS5950: Part 1 cl. 4.2.5. Each of the 51 sections, where the checks are carried out, is classified in accordance with BS5950: Part 1 table 3.4. Where the langes, out stands and the web are Class 1 (plastic) because the following criteria are satisfied: B/T≦8ε, d/t_{w}≦80ε/(1+r₁), the moment capacity is M_{c}=p_{y}Sₓ where Sₓ is the plastic modulus of the steel section.

In the “full output” the relevant data necessary to calculate the moment and shear capacity in each section are provided.

Lateral Torsional Buckling Check:

The lateral torsional buckling check is canted out in accordance with BS5950: Part 1 cl. 4.5. The secondary beams are connected to the web of the primary beams. They provide intermediate restraints. The load that they transmit is not destabilizing. Therefore the primary beam is checked for lateral torsional buckling in each span between two secondary beams, and the effective length is assumed to be equal to the spacing between the secondary beams.

The design moment in each span (M_{bar}) is the maximum applied moment (Mₘₐₓ) in the span times equivalent moment factor m. In BS5950: Part 1 (2000 draft), Table 4.4, this factor is calculated as a function of the maximum bending moment and of the values that it achieves in three equi-distant points within the span between restraints. For tapered beams, the bending moment values should be replaced by the corresponding stresses, existing in the compression flange. Therefore m factor is given by:
m=(0.2σₘₐₓ+0.15σ₂+0.5σ₃+0.15σ₄)/σₘₐₓ

The buckling resistance moment is calculated according to cl. 4.3.6.5. When at the critical position the section is Class 1, Mb=p_{b}Sₓ. The bending strength P_{b} is calculated according to Appendix B. 2.1 of BS5950 Part 1: 2000 using the properties of the cross section at the maximum bending moment position (see also Appendix B. 2.5). It is a function of the equivalent slenderness #LT that has been calculated according to cl. 4.3.6.7 and Appendix B. 2.3.

Step 2.4 Serviceability Condition

The beam is adequate at the Serviceability Condition if its deflections and natural frequency do not exceed recommended limits and if irreversible stresses are avoided. Both deflections and stresses are calculated under unfactored loads (BS5958: Part 3 cl. 2.4.1). Deflection limits depend on the application, and are input by the user.

Deflections Check

Construction Condition: self weight deflections where the structure is unpropped, the deflections due to the self-weight of the beam and the concrete slab are based on the properties of the steel beam.

Normal Condition: The deflection due to imposed load and superimposed dead load are calculated on the basis of the composite beam properties.

In case of partial shear connection, the displacement under serviceability loads can be calculated according to BS5950: Part 3 cl. 6.1.4 which includes a contribution due to slip of the shear connectors as a function of Nₐ/Nₚ:
δ=δ_{c}+0.3·(1−Nₐ/Nₚ)(δₛ−δ_{c})
where

δs is the deflection of the bare beam for the same loading

δc is the deflection of the composite beam in case of full shear interaction for the same loading

BS5950 Appendix B.3 provides a specific formula to calculate the second moment of area for uncracked section with equal flanges. This software has used a more general equation that applies also to the case of a non- symmetrical section.

Deflections Due to Imposed Loads:

BS5950: Part 3 refers to Part 1 (cl. 2.4.2) for recommendations concerning deflections limit values. BS5950 Part 1 Table 2.8 provides these values in case of beams under imposed loads only. Typical limits are span/360 for internal beams, and span/500 for edge beams supporting cladding, such as brickwork.

Deflections Due to Superimposed Dead Loads:

These deflections are calculated on the basis of the composite beam properties, and they are allowed for in the total deflection check.

Total Deflection Check:

The total deflection limit to left to the choice of the designer, because various options are possible, including the decision to precamber the beam, or even prop it during construction. For beams with a raised flange or suspended ceiling, the deflection limit of span/200 is often used but in all cases, it is recommended that the deflection does not exceed 75 mm. In case where the beam is exposed to view the deflection limit should be span/250.

Vibration Check

In calculating the dynamic inertia, the modular ratio has been reduced to represent the dynamic modulus of elasticity which is 0.9 times the static modulus. The vibration check is carried out using a simplified approach. The natural frequency (Hz) is f=18/√y₀ where y₀ is the maximum displacement of the composite beam for a load of self-weight, superimposed dead load, and 10% of the design imposed load, all applied to the composite section. The lower limit of natural frequency is 4 Hz for office applications.

Stress Checks:

The stress checks in the serviceability condition are carried out according to BS5950: Part 3 cl. 2.4.3 and 6.2. The stresses in the top and bottom flange are σₜₒₚ=(M_{sd}/Iₓₓ) yₑ and σ_{b}=(M_{sd}/Iₓₓ) (h-yₑ) In the construction condition the stresses due to the self-weight of the beam and the concrete slab are based on the properties of the steel beam. In the normal condition, the composite section properties are used.

The stresses in the extreme fibre of the steel beam should not exceed the design strength P_{y} and the stress in the concrete slab should not exceed 0.50 f_{cu}.

Stresses are controlled in order that yielding does not invalidate deflection, and also under repeated loading, there is no permanent deflection.

Stress checks are rarely critical in practical design cases.

The concrete check is not critical for unpropped construction, but can be critical for propped constructions.

Additional Checks at Openings Performed in Steps 2.2 and 2.3

Web Classification:

The web classification is carried out at four different positions around the opening. There are the points where plastic hinges are likely to occur in the Vierendeel bending failure mode. If the unstiffcned web is at least Class 2, the Vierendeel bending capacity can be calculated using the plastic properties, otherwise the elastic modulus must be used. Each web is at least Class 2 when the following criteria are met d_{eff}≦9tε or 1≦40ε
with: d_{eff}=d₁√{1−(40t_{eff}/1)²}, ε=√{275/p_{y}}
where d_{eff} is the effective depth of the unstiffened web

t is the thickness of the web

l is the effective length of the opening (see Vierendeel capacity for details)

d_{c} is the depth of the web below the web-flange depth

t_{eff} is the effective stiffness of the web (see global moment capacity for details)

Effective Width (b_{eff}):

The effective width at any position is calculated according t BS5950: Part 3 cl. 4.6 B_{eff}=x/2. The effective width has been assumed to vary linearly along the beam, according to the distance x from the supports.

Depth of Concrete in Compression (d_{c}):

The longitudinal sheal resistance R_{q} (defined in BS5950: Part 1 Appendix B2) is used to define the depth of concrete in compression d_{c}=(Dₛ−Dₚ)R_{q}/R_{c}. It replaces the net depth of the slab (Dₛ-Dₚ) in calculating the bending capacity of the composite section for partial shear interaction.

Elastic neutral axis position (Y_{c}), plastic neutral axis position (Yₚ), moment of are (Iₓₓ), elastic modules (Z_{c}ZₜZ_{b}) and plastic modulus (Sₓ):

These properties are calculated from first principles, and correspond to the properties of the reduced section at the centre-line of the openings.

Summary Checks at Openings

Vertical Shear Check:

The vertical shear check is carried out at the centre line of each opening. The shear capacity is given by the summation of the top and bottom web resistance plus the concrete contribution. The concrete contribution is calculated according to the rules for punching shear BS5950: Part 4. The vertical shear capacity is therefore:
P_{vy}=P_{vw}+Pᵥₛ with P_{vw}=0.6 P_{y}, 0.9. (A_{top.v}+A_{bot.v})
P_{vc}=v_{c.}(Dₛ−D′ₚ)[Bₜ+3.(Dₛ−D′ₚ)]

The factor of 0.9 takes account of the non-uniform shear flow within the section, and the shear strength of the steel is 0.6pᵥ, A_{top.v} and A_{bot.v} are the shear areas of the top and bottom webs (ignoring the flange area). D′p is the equivalent depth of the slab for the case when the deck is orientated parallel to the beam.

In each position a unity factors is calculated which is given by the ratio of the applied shear acting on the cross-section to the corresponding shear capacity. If the unity factor exceeds 1.0 the section fails the vertical shear check.

Global Moment Capacity:

The moment capacity at the opening position is calculated using the plastic properties of the cross-section. Therefore it is provided by the following equation Me=Sxp, >> The propel-ties of the cross-section are calculated using the effective thickness tff that allows for the interaction between shear force and bending movement. It calculated by the following formula:
t_{eff}=t.[1−((2Vₒ/V_{w})−1)²] for Vₒ/V_{w}≧0.5
Vierendeel Capacity:

Vierendeel bending is a local bending effect occurring in the top and bottom Tees of the beam due to shear transfer across the opening. This failure mode is not critical if the following inequality is satisfied:
V₀1≧ΣM_{vred}+M_{vc}
where: Vₒ is the applied shear force at centre-line of the opening

I is the effective length at the opening For a rectangular opening, it is equal to its actual length. For a circular opening, it is taken as 0.5 times its diameter. For an elongated opening, it is taken as the length of the opening minus 0.5 times its depth

M_{vred} is the Vierendeel bending resistance at each critical section, reduced by the presence of shear and the tensile force, T. It is calculated by the following formula:
M_{v,red}=Mᵥ[1−(T/T_{y})²]

T_{y} is the tensile resistance of the web-flange Tee section

Mᵥ is the Vierendeel bending resistance of the section. It is calculated using elastic or plastic properties depending on the class of the web. In order to take account of the interaction between shear and bending moment, an effective thickness of the webs is defined which is calculated as follows:
t_{eff}=t.[1−((2Vₒ/P_{w})−1)²] for Vₒ/V_{w}>0.5

P_{vw} is the shear resistance of the web-flange Tee section

M_{vc} is the Vierendeel resistance due to local composite action of the top of the web-flange Tee with the connected slab. It is calculated as:
M_{vc}=NQₚ(Dₛ+yₜ)

N is the number of shear connectors in the length (1+D_{d})

Qₚ is the capacity of a single shear connector

Dₛ is the depth of the slab

Yₜ is the distance of the centre of area of the top tee from the top flange of the steal beam

Web Buckling Check:

The buckling capacity of the web at the edge of each opening is checked using a modified strut approach. The axial force on the element adjacent to the opening is the shear resisted by the top Tee. The buckling capacity is calculated as:
P_{w}=d_{eff.}t.p_{c}
where: d_{eff} is the effective width of the strut calculated as:
D_{eff}=min [0.5dₒ0.25s_{o.eff}]

S_{o.eff} is the effective width of the web post. It depends on the value of its actual width (sₒ) and depending on the shape of the opening it is calculated as:

S_{o.eff}=sₒ for a rectangular opening

S_{o.eff}=Sₒ+0.5dₒ for a circular or elongated opening

Sₒ is the width of the web post

p_{c} is the buckling stress corresponding to the buckling curve c in BS5950: Part 1 Table 4.14. It depends on the slenderness λ=h_{eff}/r,

r, is the radius of gyration (=t/√12)

h_{eff} is the effective length of the strut element. For a rectangular opening it is equal to its depth. For a circular opening, it is taken as 0.7 times the depth of the opening.

This failure mode is not critical if the following inequality is satisfied: Vₜ≦P_{w}, For a symmetric opening Vₜ=Vₒ/2

Horizontal Shear in the Web Post:

The program carries out this check only when two adjacent openings are closer then 2.5d_{o.max} where d_{o.max} is the diameter of the larger opening. The horizontal shear developed in each web post is due to the change in axial force in the corresponding adjacent Tees. Therefore it is calculated from equilibrium of the top web post, using the following forrnula:
Vₕ=Vₜ(sₒ+0.5d_{o,i}+0.5d_{o,i+1})/hₜₒₚ
where: Vₜ is the part of the global shear at the section acting on the top Tee section

hₜₒₚ is the distance between the mid-point of the web-post width and the effective line of action of the axial force in the top Tee section.

d_{o,i}d_{o,i+1} are the depth of the two adjacent openings.

The shear capacity of the web post is obtained by the following equation: Pₕ=0.6 p_{y.t.} (0.9sₒ). The factor 0.9 takes account of the non-uniform shear flow. This failure mode is not critical if the following inequality is satisfied: Vₕ≦Pₕ

It will be apparent that any other parameters or properties may be provided or calculated as desired.

In the present specification “comprise” means “includes or consists of” and “comprising” means “including or consisting of.”

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of designing a structural element comprising providing a value for a plurality of parameters of the structural element and a plurality of loads to be supported thereby, performing an analysis step of calculating a plurality of properties of said structural element at a plurality of discrete locations on said structural element, and displaying the results of said analysis step.

2. A method according to claim 1 wherein, where the structural element is to comprise an aperture, at least one of said parameters may be a parameter of said aperture and at least one of said properties may be a property of said structural element at said aperture.

3. A method according to claim 1 or 2 comprising a comparison step of comparing at least one of said properties with a predetermined criterion.

4. A method according to of claim 1 wherein said plurality of locations comprises a plurality of sections of said structural element located to be longitudinally disposed along said structural element.

5. A method according to claim 4 comprising the step of displaying the section wherein a desired one of said properties has a value having the greatest deviation from said predetermined criterion.

6. A method according to claim 5 comprising the step of changing the value of one or more of said plurality of parameters such that said deviation of the value of said property from said predetermined criterion is reduced.

7. A method according to any one of claim 4, 5 or 6 wherein a plurality of properties are compared with a corresponding one of a plurality of predetermined criteria.

8. A method according to any one of claim 4, 5 or 6 wherein said comparison of each value for a property and a corresponding predetermined criterion is expressed as a unity factor such that where said unity factor is greater than 1, the value for said property fails to meet said predetermined criterion.

9. A method according to claim 1, 2, 4, 5 or 6 wherein said structural element comprises a web and at least one flange and said parameters comprise the web and flange thickness and depth.

10. A method according to claim 1, 2, 4, 5 or 6 comprising selecting at least one of said parameters of said structural element and said load applied to said structural element from a library of predetermined values for said parameters and said load.

11. A method according to claim 1, 2, 4, 5 or 6 comprising calculating a unity value for a plurality of properties for each discrete location, and for each property displaying the location with the least acceptable unity value.

12. A method according to any claim 1 comprising an output stage of providing an output comprising the parameters of the structural element.

14. A method according to claim 13 wherein said output is provided in a portable or transmittable form.

15. (canceled)

16. A method according to claim 1 further comprising the step of manufacturing structural element so designed.

17. A method according to claim 14 and manufacturing the structural element to comprise plate metal.

18. A method according to claim 14 and manufacturing the structural element to be provided with apertures.

19. A method according to claim 14 and manufacturing the structural element to comprise a composite beam.

20. (canceled)

21. A method according to claim 14 and using a computer program for performing the method steps.

22. A method according to claim 21, further comprising programming a computer with a computer program for performing the method steps.

23. Method according to claim 22 further comprising the step of utilizing the computer to control a manufacturing apparatus for manufacturing the structural elements wherein an output is supplied from said computer to said manufacturing apparatus to control said manufacturing apparatus.

24. A method of manufacturing a structural element comprising supplying an output from a computer program according to claim 23 and wherein an output is supplied from a computer program to a manufacturing apparatus to control said manufacturing apparatus.

25. A method according to claim 24 wherein the step of supplying an output from a computer program comprises the step of preparing a data file.

26. (canceled)
